(19) United States
(12) Patent Application Publication
(10) Pub. No.: US 2017/0113248 A1
(43) Pub. Date: Apr. 27, 2017

(54) METHOD FOR PRINTING DIRECTLY ONTO BOARDS OF WOOD-BASED MATERIAL

(71) Applicant: Kronoplus Tehnical AG, Niederteufen (CH)

(72) Inventors: Dieter Dohring, Zabeltitz (DE); Hans Schafer, Zabeltitz (DE); Udo Hanitzsch, Zabeltitz (DE); Gary Blenkhorn, Cape Elizabeth, ME (US)

(21) Appl. No.: 15/397,276

(22) Filed: Jan. 3, 2017

Related U.S. Application Data
(63) Continuation of application No. 12/516,084, filed on Apr. 19, 2010, now abandoned.

(30) Foreign Application Priority Data
Nov. 23, 2006 (EP) PCT/EP2006/011246

(51) Int. Cl. B05D 7/08; E04F 15/04; B05D 3/02; B05D 3/06; B05D 3/12

(52) U.S. Cl. CPC B05D 7/08; B05D 3/067; B05D 3/12; B05D 3/0254; E04F 15/04

(57) ABSTRACT

The present invention relates to a method for coating a board of wood-based material, in particular a board of real wood, a plywood board or a board for parquet flooring, with a flowable plastics material. The method comprises applying the plastics material as a single, thick layer to the board of wood-based material (6) and creating an impressed structure by means of a material web (3) or a structure roller. After creating the impressed structure, the plastics material is cured to produce a wear resistant surface.

### FIELD OF THE INVENTION

The invention relates to an apparatus and a method for the coating of boards, in particular of boards made of wood materials for the production of flooring panels, with a flowable coating material.

### BACKGROUND

From the art, numerous boards made from wood material for the production of flooring panels are known. Boards made of solid wood have an esthetically particularly appealing surface, however, they are very expensive. For this reason, boards made from wood veneer were developed which comprise a basis plate made from a relatively inexpensive wooden material, as e.g. an inexpensive kind of wood, onto which a thin layer of veneer of a wood type of higher quality is applied. However, also boards made from wood veneer are relatively expensive so that many consumers prefer laminate panels. Laminate panels consist essentially of a base plate in a thickness of approx. 6-8 mm made from MDF or HDF material, onto which a décor paper is glued. The layer of décor paper is impregnated and is usually further provided with abrasion resistant particles. During the manufacture of the laminate panels, the resin is cured by means of pressure and heat and an extremely abrasion resistant and decorative surface is generated. Lately, new methods were developed to print boards made from wooden material, such as MDF or HDF, directly with a plastic material, i.e. without the usage of a décor paper.

To this aim, e.g. an MDF board is grinded and provided with a primer. In a second step, a colored décor is printed onto said primer, like e.g. a décor featuring real wood. After that, a plurality of very thin material layers is applied, wherein the single material layers are each cured before the next layer is applied. The material layers are e.g. multiple, essentially transparent paint layers made from a curable plastic material. The resulting total layer has thus a layer-wise structure. Boundary layers are generated between the single layers, in which no satisfactory interlacing occurs. The single layers usually have a thickness of 10-15 μm and commonly 5-7 layers are applied above each other, such that the overall strength of the thin layer system or the layer stack is approx. 50-105 μm.

As the name boards made of wood materials implies, this expression shall include herein wood materials in its broadest sense, as for example boards made from wood, respectively boards made using wood materials. This group includes exemplary, but is not limited thereto, hoards made from OSB (oriented strand board), MDF or HDF, particle board, solid or massive wood, veneer and pre-finished floor and others. The invention in particular relates to improved boards from wood materials to be used as a floor covering or as a covering for a wall or a ceiling.

From document DE 20 2004 018 710 U1 an apparatus for the continuous coating of boards is known. Multiple boards are arranged onto a conveyor belt, which are moved individually and sequentially among others to coating stations. Such a coating station comprises an applicator roll, with which a paint is applied onto a board. Following this, a finishing apparatus is arranged, by means of which the paint is e.g. cured by means of UV radiation. The applicator roll may comprise a structured surface to apply paint in a structured manner onto the surface of the board.

From document DE 20 2004 018 710 U1, it is also known to apply paint by means of a jet printing technique, which is in particular known from inkjet printers, structured onto a surface of a board. This is again followed by a finishing apparatus, with which the coating can be cured.

Also known from document DE 20 2004 018 710 U1 is a coating of workpieces as e.g. plates, which are provided with an adhesion promoting layer, and a primer layer. Arranged thereon is a printing layer, which constitutes a décor. Above the décor, a layer of paint is arranged. A so-called filled paint may be used therefor. Such filled paints are paints comprising extremely fine solid particles as e.g. corundum, having a cross-section in the range of nanometers.

From document DE 103 58 190 A1, a method for the control of printing machines is known. With the apparatus known from this document, boards for furniture are printed.

It is the aim of the invention to provide a new apparatus and a new method, with which a fast and cost-efficient coating of boards, in particular for the production of flooring panels, with a good quality, is possible.

These and other aims, which may be derived from the following description are solved by the present invention.

### DETAILED DESCRIPTION OF THE INVENTION

To solve the object of the invention, the apparatus comprises transport means for the transport of boards. The apparatus comprises a supply arrangement, with which coating material may be applied onto the surface of the boards. Following the supply arrangement, means for drying and/or curing of the coating materials are provided above the board. In contrast to the above-mentioned prior art document DE 20 2004 018 710 U1, the apparatus according to the invention comprises means to lead a web between the transport means for the transport of boards and the means for drying and/or curing.

If a web with a structured surface is applied, the surface of the coating materials may be provided with a structure without the necessity to apply any significant pressure. Since the coating material is dried in this condition and/or cured, the coating of a board with a structured surface is achieved, without the need for usage of a press as it is known from the prior art disclosed in document DE 20 2004 018 710 U1, or alternatively a complex printing device. Additionally, a coating applied in multiple steps may uniformly be dried and/or hardened in a single production step. It is in particular possible to provide a chemical network, which extends through the whole structure of the layer, which leads to a particularly stable coating.

If a web with a smooth surface is used, a drying and/or curing under exclusion of air is possible. A drying and/or curing under exclusion of air is often desirable, e.g. to achieve a particularly large amount of interlacing that means a particularly large amount of double bondings in the paint, in the case of a curing of the paint by means of UV light. In the case of a curing by means of electron beams, an exclusion of air is usually required.

The invention also relates to a new method for coating a board made of wooden material, in particular of particle-, MDF- or HDF-board, with a flowable plastic material. The method in particular relates to the production of panels as e.g. the production of flooring panels. In this method, a thick layer of preferably at least 30 μm of plastic material is applied in a single processing step onto the wood material board. The plastic material is at least after drying or curing preferably transparent. The layer is preferably applied in a single process step in a thickness of 30-150 μm, particularly preferred in a thickness of 80-110 μm and most preferred in a thickness of approx. 95 μm. In a further step, the layer of plastic material is cured. The usage of a single thick layer instead of a series of multiple thin layers provides several advantages. For once, larger abrasion resistant particles as e.g. larger corundum particles, may be provided, compared to a thin layer system. With thin layer systems, in which the individual thin layers have a thickness of only 10-15 μm and which are each separately and subsequently cured, only relatively small particles can be used, since the particles should be bonded preferably as deep as possible into the layers.

The flowable plastic material is preferably an acrylate system. Herein, the term acrylate system is understood to be e.g. a polymerization capable mixture of mono-, di-, and multiply functional double bondings containing acryl-acid based compounds. Typical examples are dipropylen glycol diacrylate, 1,6-hexane diol diacrylate, polyurethane-acrylic ester or polyester-acrylic ester, as they are commercially available from the company BASF under the trademark name Laromer™.

The wood material board is preferably provided with a colored décor printing as e.g. a décor imitating real wood, before it is coated with the flowable plastic material. The plastic material is applied over the décor printing and is preferably as transparent as possible. The method may e.g. comprise the following steps:

First, the carrier board as e.g. an MDF board is finely grounded and aligned respectively calibrated. After that, a primer and preferably an undercoat are applied. Following that, the printing of the decor onto the primer respectively the undercoat is effected. In a further step, an additional primer is supplied, which is preferably a suitable primer for the subsequently following layer of plastic material. This primer is preferably applied in an amount of up to 10 g/m², and particularly preferred of approx. 5 g/m². Afterwards, e.g. a single thick layer of an acrylate system is e.g. applied by means of an applicator roll onto the primer. This is preferably done in an amount of up to 100 g/m², particularly preferred of Up to 65 g/m². Preferably ground particles are spread onto the not-yet hardened acrylate system and depending on the desired abrasion class in an amount of up to 70 g/m², preferably 45 g/m². Over this layer, preferably a finishing paint layer is applied, by means of a structure applying sheet with preferably 2-100 g/m², particularly preferred 30 g/m². Finally, all layers are preferably cured in a single process step by means of UV radiation. The cured acrylate system is preferably as transparent as possible to make the underlying décor painting visible.

The curing of the plastic material is effected preferably by means of a polymerization of the plastic material, and not by means of a polycondensation. The plastic material is thus preferably an acrylate system which is polymerizable. The plastic material, as e.g. the polymerization capable acrylate system is particularly preferred as a plastic material, which may be cured by means of UV radiation. In this case the UV radiation serves to start the polymerization. Since the polymerization can be stopped at any time, it is thus possible to provide a graded interlacing in the single thick layer, which may be e.g. 95 μm, and thus to provide a graded curing. The graded curing is generated by means of a singular polymerization which takes place over the whole layer thickness, with a preferably complete conversion. This is in contrast to the painting with multiple thin layers, wherein the same are applied layer by layer and then precured by means of radiation, in other words, the reaction is prematurely terminated. Therefore, no continuous polymerization is achievable over the whole cross-section of all layers, but boundary layers are generated.

In an advantageous embodiment of the method multiple layers are applied by means of a wet-on-wet method (as e.g. primer, acrylate (by means of an applicator roll), corundum; finishing paint), and polymerized in a single step by means of preferably UV excitation. The acrylate layer is according to the invention cured in a single thick layer. The individual layers differ in their function and thus also in their chemical structure: The function of the primer is to provide a good adhesion between printing and plastic layer. The middle layer is provided flexible to reduce inner stresses and to prevent brittling, as well as to absorb impact energy, created from foot steps, when the coated board is e.g. used as a flooring panel. The finishing paint however is modified such that it has a high hardness and stretch resistance. Since a mixing of the layer occurs during the wet in wet method, no boundary layers exist, but rather a graded hardness from the top to the bottom.

Chemically speaking: The polymerization is in fact such that an almost complete double bonding conversion is achieved over the whole layer. The primer is preferably designed such that by means of a high amount of functionalization of the acrylate mixture, a better adhesion is achieved. The middle layer is particularly provided with a chain growth and with only minor interlacing. The finishing paint contains an acrylate system which is highly interlacing capable.

To increase the abrasion resistance of the layer, preferably abrasion resistant particles, in particular corundum particles, are introduced into the layer. Since the layer is very thick, it is possible to introduce relatively thick particles, which have better abrasion properties as smaller particles. Depending on the layer thickness, e.g. corundum particles in the range of DF 220-DF 280 according to FEPA specification (Federation of European Producers of Abrasives) are employed. These have an average grain size D50 of 63.0-36.5 μm. Particularly preferred are particles in the range of DF240-DF280 and are employed, i.e. with a grain size of D50 of 44.5-36.5 μm. With a layer system with multiple thin layer systems as mentioned above (so-called thin layer systems) which are applied above each other, relatively small particles (as e.g. corundum particles) have to be employed, since the same would otherwise protrude to much out of the single layers. The particle size in this case is in the range of DF320-DF550 according to FEPA specification. In other words, the usable grain size of the abrasion resistant particles was up to now limited to an average grain size D50 of 29.2-12.8 μm. These relatively small particles result, if applied in the same amount, to lower abrasion values, i.e. for the same abrasion class, a larger amount per weight has to be used with fine particles as is the case with larger particles.

Further, fine particles lead to an impaired transparency of the surface and to a graying of the same. The introduction of the particles into the layer can be effected after application of the layer, by spreading the particles e.g. onto the not-yet hardened layer. After the particles are immersed into the layer or have been pressed into the same, the material is cured, so that the particles are firmly enclosed in the layer. Another possibility is to introduce the particles before the application of the layer into the flowable plastic material, e.g. in the form of a dispersion.

In a preferred embodiment, a web with a structured surface is arranged basically without applying pressure onto the layer of plastic material before the curing step, i.e. after the layer is applied onto the plate. In this way, a structure is impressed or embossed into the layer of plastic material. Since at that time, the layer is still liquid, virtually no pressure has to be applied. In a next step, the layer of plastic material is dried and/or cured, whereby the structure impressed into the layer of plastic material is fixed. Afterwards, the web with structured surface can be removed in a further process step. In an alternative method, a structural roll is used to impress a structure into the layer of plastic material. This is again done after the application of plastic material onto the board but before the curing of the plastic material. Preferably directly after the imprinting of the structure, the layer of plastic material is dried and/or cured in a following step, whereby the structure imprinted into the layer of plastic material is fixed. Due to the large size of the layer according to the invention, a depth of the structure of 0-80 μm is possible. Particularly preferred is a depth of the structure of 20 up to 80 μm and even more preferred up to 35 μm. In the art, when a layer system of multiple thin layers was employed, it was up to now not possible to produce depths of the structures of more than 5-10 μm.

These relatively shallow depths of the structures are not sufficient for many applications. For example, to realize a realistic imitation of real wood, deeper structures have to be impressed into the layer. With the very deep structures according to the present method, patterns and structures may be introduced into the layer, which are esthetically particularly advantageous and which were up to now not possible. A depth of the structure of 35 μm is clearly palpable and visible with the naked eye and is particularly suitable to imitate the structure of real wood floorings.

In an alternative embodiment, a web with a smooth surface is placed without the application of significant pressure onto the layer of plastic material. In this way, it is prevented that air reaches the plastic material. In a next step, the layer of plastic material is dried and/or cured under exclusion of air. In a further step, the web with smooth surface is removed again.

The webs employed, whether with a smooth or a structured surface, are preferably penetrable by UV radiation. If a plastic material is employed, which can be cured by UV radiation, it is possible to cure the plastic although the same is covered by the web.

The disclosed method offers in particular advantages for the coating of hoards from wooden materials made from real wood, as for example veneer or parquet, as for example pre-finished floor parquet. Up to now a disadvantage of such real wood boards was that the surfaces thereof are relatively sensitive. With the inventive method now also floorings made from real wood can be provided with a coating, which achieves high abrasion resistance values and which has nevertheless due to the provided three dimensional structure an aesthetic pleasing surface. In the art, if one tried to provide real wood flooring with an abrasion resistant coating to increase the life-time of for example floorings from such materials, the three-dimensional natural structure of the real wood proved to be disadvantageous. The lacquer or coating applied in moist condition tends to flow into the recesses of the natural structure of the wood, such that the coating of the protruding areas between the recesses is unsatisfactory. If one applies, however, a thicker coating, to protect also the protruding areas between the recesses thereby, the three-dimensional natural structure of the real wood is completely covered, such that undesirable smooth surfaces result. Such a smooth surface has a negative effect to the optical appearance, which is intended to be achieved by the three-dimensional structures, namely the impression of a real wood material. The problem of the covering of the natural structure of the real wood occurs already with very small thicknesses of the coating. In the prior art it was tried to solve this problem by machining deeper structures into the real wood surface. This additional process step, however, increases the costs of the product and it further complicates the application of the coating due to the problem described above, i.e. that the liquid coating material collects in the recesses. Although these problems were known for some time, up to now it was not possible to solve them in a satisfactorily manner. With the present invention now for the first time the opportunity arises to coat also boards from real wood with an abrasion resistant coating, which due to a suitable imprinted three-dimensional structure nevertheless conserves satisfactorily the desired aesthetical properties of real wood boards. With the present invention it is in particular for the first time possible to produce real wood flooring from real or solid wood, as for example timber floor boards, or boards made from veneer or ready to use parquet, with high abrasion resistant values, which nevertheless have a three-dimensional surface structure, which gives the impression of real wood material.

In one embodiment of the invention, the supply arrangement comprises a collecting arrangement for the coating material arranged adjacent to the transport means for the transport of the boards. The collecting arrangement is further adjacent a roller for the transport of the web. The collecting arrangement is built such that liquid coating material, which is provided in the collecting arrangement, flows to the roller. In this way, it is achieved, provided that the collecting arrangement is sufficiently filled with the material, that liquid coating material may completely cover a web with a liquid film, when a web is transported over the roller. Together with a sufficient supply of liquid coating material one can achieve that the liquid coating material completely fills the space between the surface of the board and the web positioned above the board. The introduction of air into this area is thus particularly reliably prevented. A curing can thus particularly reliably be carried out under exclusion of air.

Additionally, with this embodiment it is possible to apply relatively thick layers of paint with a total thickness of e.g. 80-100 μm and uniformly day and harden the same. This in turn allows to incorporate relatively thick abrasion resistant particles like e.g. corundum with a cross-section of up to 100 μm into the paint. Since the abrasion resistance increases with the diameter of the abrasion resistant particles in this way a relatively good abrasion resistance may be achieved. With increasing diameter of the abrasion resistant particles, at the same time the amount of abrasion material can be reduced. In this way, an improvement of the abrasion values as well as an improvement of the transparency of the abrasion resistant coating is achieved.

Particle grain sizes of DF 220 to DF 280 FEPA are particularly preferred. The thickness of the layer is preferably 30-150 μm, and particularly preferred 80-110 μm.

In one embodiment of the invention, the means for the transport of the boards comprise a circulating conveyor onto which the boards are arranged for transport.

In a preferred embodiment of the method, other materials are introduced into the layer after the application of the layer of plastic material, but before the curing or drying of the same, e.g. by spreading, to achieve e.g. an esthetically appealing effect. The other materials are preferably natural or biological materials, as e.g. cork or hemp, but also plastic or metal particles may be suitable. The other materials can be introduced such that they protrude relief-like from the layer or in a way that they are completely sunken into the layer. The layer is preferably transparent, such that other materials enclosed therein are visible. For example, leaves or tree needles may be introduced into the material layer, which are preferably completely sunken into the layer and completely enclosed by the same. After that, the transparent layer is cured. Since the e.g. natural materials are completely enclosed in the layer, which could for example be an acrylate resin, and thus protected from air and environment, no decay of the natural materials occurs. A board treated in this way, with a transparent hard plastic layer, in which other materials are introduced, may thus have an esthetically extremely appealing effect. Further possible materials are e.g. leaves, twigs, branches or wool. The introduction of other materials is possible due to the relatively large thickness of the layer.

In one embodiment of the invention, the web is rolled off from a roller, passed by means of further rollers parallel to the surface of the boards, which are transported and the web is then again rolled onto another roller. In contrast to the prior art mentioned above, an exchange of the web is sufficient if a surface structure is to be modified or if a structure of the web comprises damages, e.g. due to wear. By means of the application of the web additionally a uniform quality of a generated surface structure can be assured, since in contrast to a roller with a structured surface, the quality of the surface of the web is not changed by the de-winding of the web, which generates the structure. Additionally, the structure in the surface of the coating is generated essentially without pressure, such that the surface of the web does advantageously show no signs of wear for this reason.

In one embodiment of the invention, the rolls for the transport of the web are arranged such that they form a funnel or hopper in cross-section with the collecting arrangement. The supply of coating material to the surface of a board is thus effected by means of a gap. In this way, the proper supply of coating material between the web and the surface of the hoard to be coated is further improved.

In one embodiment, the width of the above-mentioned gap can be varied. This serves to control the amount of coating material which is supplied to the surface of the board. In one embodiment, the gap may be closed, in order to control the point of supply.

### DESCRIPTION OF PREFERRED EMBODIMENTS

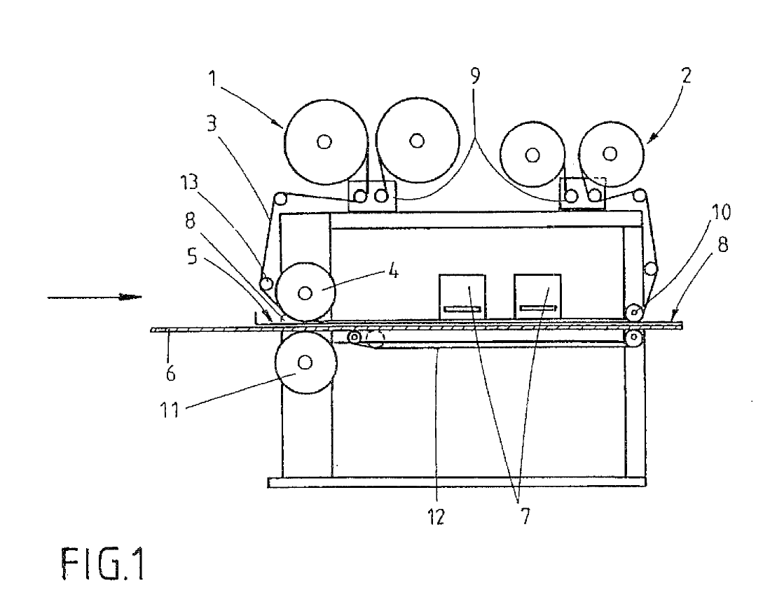

In the following, the invention is explained in more detail with reference to FIG. 1. FIG. 1 shows an apparatus by means of which a carrier material 6 as e.g. a particle-, MDF- or HDF-board may be coated in a continuous way. As coating materials, preferably UV or electron beam cross-linkable flowable systems with suitable viscosity are used.

At the entrance of the coating apparatus, a earlier material 6 is supplied and coated with a flowable material 8. The coating is effected by means of a collecting arrangement 5, which is arranged adjacent to a roller 4. A web-like material, namely a radiation resistant, UV and/or electron radiation transparent foil 3 is passed over the roller 4. The foil comprises a smooth surface oriented to the coating material 8, if the coating 8 is intended to have a smooth surface. The corresponding surface of the foil 3 comprises a structure if the coating 8 is to be provided with a structured surface.

The web-like material, respectively the foil 3 is rolled off from a supply roll or supply roller 1, and finally rolled onto a roller 2. Between roller 1 and roller 4, three further rollers with smaller diameter are arranged along the route of transportation for the web-like material 3, which serve for the guiding of the web-like material. The supply roller 13 with the smaller diameter, which is arranged adjacent to roller 4, effects together with roller 4 that the web-like material forms together with the collecting arrangement 5 a funnel-shaped entrance for the coating material 8. The coating material 8 is e.g. paint, and is suitably supplied by means of this funnel shape between the carrier material 6 and the web-like material 3.

The entrance with a funnel-shaped cross-section leads to a gap. The width of the gap may be adjusted in order to control the supply of coating material.

Between the roller 4 and the roller 2, four further guiding rollers with smaller diameters are arranged, which serve for the guiding of the web-like material from roller 4 to roller 2. The first guiding roller 10—as seen from roller 4 in the transport direction of the web-like material—effects together with roller 4 that the web-like material is guided parallel to the surface of the carrier material 6.

Between roller 4 and roller 10 and above foil 3, devices 7 are arranged, by means of which the underlying coating material may be dried and/or cured. These devices are in particular devices for the curing by UV light or electron beams.

With the apparatus, a web-like smooth or structured material 3 is aligned during the coating process from supply roller 1 in longitudinal direction as well as a transverse direction and is applied synchronously by means of the roller 4 and the collecting arrangement 5 to the carrier material 6 onto the still liquid coating material. The aim of the aligning of the web-like material is to synchronize certain locations of carrier material 6 with certain locations of the web-like material with each other. To this end, in one embodiment of the invention, the speed of a carrier material respectively a board 6 is measured by means of measuring systems. Preferably optical measuring systems are applied to detect the speed of the carrier material. The speed of rotation of at least one of the rollers is e.g. measured by means of electronic or automatic sensor means, which roller is involved in the transport of the web-like materials. The data of the transport speed of each board 6 and the transport speed of the web-like material thus obtained are used for the controlling. Both speeds are controlled such that a board can be joined with the web-like material in a defined way for a controlled structuring of a surface.

In one embodiment of the invention, the web-like material comprises e.g. optical markings, which may be detected by optical sensors. The transport of the web-like materials and/or the transport of the boards 6 are controlled such that a board is coated in dependence of such an optical marking and the coating is structured depending on these optical markings. The carrier material with the liquid coating material and the web-like material on top of it passes subsequently through the curing station 7. In this station, the liquid coating material 8 is cross-linked and merges to a solid state. In doing so, the surface structure of the web-like material is fixed with the hardened layer during the curing process and imprinted therein.

At the exit of the coating apparatus, the web-like material is pulled off from the hardened solid coating material and rolled up again on a roller.

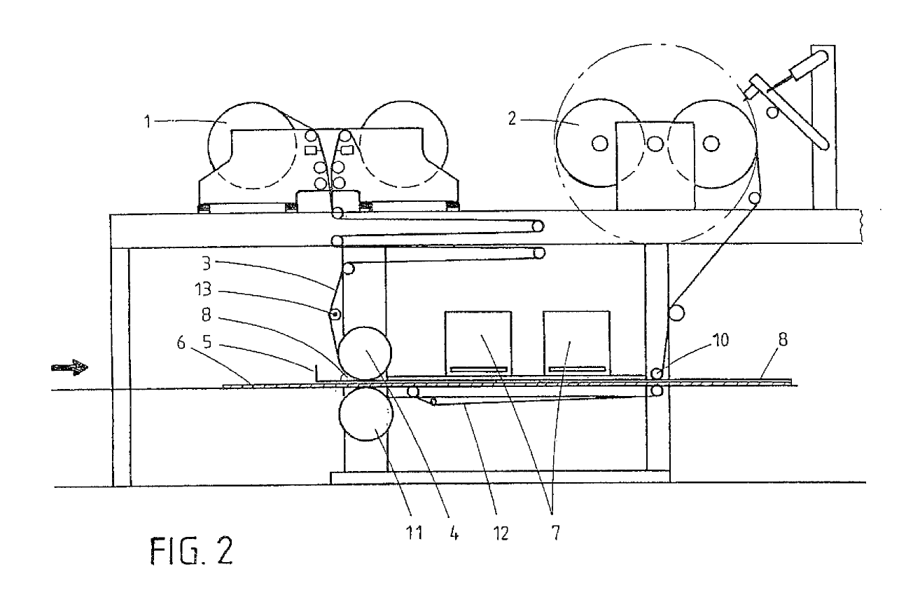

In the embodiment shown in FIG. 2, several supply rollers 1 and reel-up rollers 2 are provided for the web-like material. The supply rollers and the reel-up rollers can be connected during the Panning production by means of a suitable arrangement without any stop.

The connecting is effected preferably at speeds of not more than 120 m/min for reasons of practicality. The respective foil receiving station, which is in its idle state, is fed with a roll of the web-like material and the automatic connection is prepared by gluing a double-sided adhesive tape onto the beginning of the web. The beginning of the web-like material is introduced into a gap which serves for connecting. The web-like material, which is being reeled is guided at the same time through this gap. The effecting of the connecting is conducted automatically by means of an electronic sensing of the amount of the spent roll, from which the web-like material is being reeled or by means of the sensoric detection of the respective end of a web-like material. Prior to the connection, the dereeling web-like material is stored in a dancer roll device which works as a supply store. The driven roll is reduced to a chain speed of approx. 15 m/min. The missing length of the web-like material in relation to the speed of the device is pulled out of the dancer roll. After the connecting process, the corresponding foil roil accelerates again up to the maximum speed of e.g. 120 m/min, until the dancer roll has reached again its work position.

The device for the automatic connection comprises at least two dereeling stations, having hingable supports and pneumatic tension rolls. The drive of the dereeling is effected by means of a servo motor each and means are provided to automatically adjust carriages with the foils, respectively the web-like materials. The actual connection device comprises four pneumatically actuated mangle rolls. Further, two cutting knives are provided for the cutting of the web-like material after connection. An automatic brake force regulation is provided for the dereeling rolls. The same comprises dancer rolls, pneumatically proportional controllable linear cylinders, having guiding and diverting rollers, having an automatic break control.

The carrier material, respectively a board 6 is first passed between the two to rotating rollers 4 and 11, which are arranged stacked over each other and thus transported. From this point, the carrier material 6 is passed to a transport belt which transports the carrier material even further. The web-like material respectively the foil 3 and the carrier material 6 are transported with the same speed.

The distance between the rollers 4 and 11 can be adjusted to vary the thickness of the coating. In one embodiment, also the height of the guiding roller 10 may be changed to influence the thickness of the coating.

1. A method for coating a board of wooden material with a flowable plastic material, wherein the method comprises the following steps:
applying the plastic material as a single layer onto the board of wooden material, wherein the layer is applied in a single process step in a thickness of at least 30 μm;
arranging a web with a structured surface onto the plastic material independent of any pressure being applied by a press, to provide the layer of plastic material with a structure;
drying and/or curing the layer of plastic material, whereby the structure introduced into the layer of plastic material is fixed, and
removing the web with the structured surface, wherein the plastic material increases the abrasion resistance of the board of wooden material.

2. A method for coating a board of wooden material with a flowable plastic material, wherein the method comprises the following steps:
applying the plastic material as a single layer onto the board of wooden material, wherein the layer is applied in a single process step in a thickness of at least 30 μm;
embossing a structure into the layer of plastic material by means of a structured roller, before the layer of plastic material is cured, to provide the layer of plastic material with a structure; and
drying and/or curing the layer of plastic material, whereby the structure introduced into the layer of plastic material is fixed, wherein the plastic material increases the abrasion resistance of the board of wooden material.

3. A method according to claim 1, wherein the structure has a depth of up to 80 μm.

4. A method according to claim 1, wherein the web is transparent for UV light.

5. A method according to claim 1, wherein the plastic material is a plastic, which is curable by means of UV radiation.

6. A method according to claim 1, wherein the layer is applied in a single process step in a thickness of 30-150 μm.

7. A method according to claim 1, wherein, after application of the layer of plastic material and prior to the provision of the structure, abrasion-resistant particles with a grain size D50 of 36.5-63 μm and are embedded into the layer of plastic material, to increase the abrasion resistance of the layer.

8. A method according to claim 1, wherein, prior to the application of the layer of plastic material, abrasion resistant particles with a grain size D50 of 36.5-63 μm are embedded into the layer of plastic material to increase the abrasion resistance of the layer.

9. A method according to claim 1, wherein the plastic material is a polymerizable acrylate system.

10. A method according to claim 1, wherein the curing of the plastic material is effected by means of a polymerization of the plastic material.

11. A method according to claim 1, wherein, after the application of the layer of plastic material, other materials are introduced into the layer, to provide an esthetical effect.

12. A method according to claim 1, wherein the board of wooden material is a real wood board, a veneer board or a parquet board.

13. A method according to claim 1, wherein the layer is applied in a single process step in at thickness of 80-110 μm.

14. A method according to claim 1, wherein the layer is applied in a single process step in a thickness of approximately 35 μm.

15. A method according to claim 7, wherein the abrasion-resistant particles include corundum particles.

16. A method according to claim 8, wherein the abrasion-resistant particles include corundum particles.

17. A method according to claim 11, wherein the other materials include one or more of straw, tree needles and metal cuttings.
